(19) United States
(12) Patent Application Publication
(10) Pub. No.: US 2026/0104814 A1
(43) Pub. Date: Apr. 16, 2026

(54) DATA STORAGE METHOD AND DEVICE

(71) Applicant: Samsung Electronics Co., Ltd., Suwon-si (KR)

(72) Inventors: Kuan GAO, XiAn (CN); Huimei XIONG, XiAn (CN); Qijie SUN, XiAn (CN); Chao LIN, XiAn (CN)

(73) Assignee: Samsung Electronics Co., Ltd., Suwon-si (KR)

(21) Appl. No.: 19/061,120

(22) Filed: Feb. 24, 2025

(30) Foreign Application Priority Data
Oct. 12, 2024 (CN) 2024 1 1422853.4

(51) Int. Cl. G06F 3/06

(52) U.S. Cl. CPC G06F 3/0655; G06F 3/061; G06F 3/0679

(57) ABSTRACT

A data storage includes: determining, in response to receiving an IO request, a data response level for the IO request; determining, according to the data response level, a storage area for storing data to be written corresponding to the IO request in a UFS device, the UFS device comprises a high speed buffer and a normal storage area; and writing the data to be written into the determined storage area, wherein the high speed buffer comprises a first area, a second area, and a third area, and the UFS device is configured block data stored in the third area is from being flushed into the normal storage area. The speeds of the high speed buffer are greater than the speeds of the normal storage area. The first area, the second area, and the third area and the normal storage area correspond to different data response levels, respectively.

### CROSS-REFERENCE TO RELATED APPLICATIONS

This application is based on and claims priority under 35 U.S.C. § 119 to Chinese Patent Application No. 202411422853.4, filed on Oct. 12, 2024, in the China National Intellectual Property Administration, the disclosure of which is incorporated by reference herein in its entirety.

### BACKGROUND

Some example embodiments relate to data storage, and more specifically, to a data storage method and device.

An application reads data from a storage device and/or writes data into the storage device frequently during operation. FIGS. 1A and 1B illustrate an example of data read and write speeds during operation of a particular game application and an example of data read and write speeds during operation of a particular shopping application, respectively.

Referring to FIGS. 1A and 1B, the game application writes a large amount of data of about 15 Gigabytes to the storage device over a period of 25 minutes, and the shopping application read and wrote a small amount of data over a period of 10 minutes.

As can be seen, the read/write behaviors of different applications vary greatly and the read/write speeds of each application varies with time and users' behaviors, and the write speed of the applications spans a wide range (e.g., from 2 MB/s to 800 MB/s).

In order to improve the write performance of a storage apparatus, Turbo Write (TW) technology may be used. The TW technology writes data to a fast storage device (e.g., Single Level Cell (SLC) flash) used as a cache of the storage apparatus, and then migrates all the data in the fast storage device to a slow storage device of the storage apparatus when the storage apparatus sleeps.

FIG. 2 illustrates a schematic diagram of an example of reading and writing data based on the TW technology.

Referring to FIG. 2, all data of an Android system and applications are written to an SLC cache (e.g., the SLC region) of the Universal Flash Storage (UFS) device, and then the data in the SLC cache is flushed into a Multi-Level Cell (e.g., one or more of Triple-Level Cell (TLC) or a Quad-Level Cell (QLC)) region while the UFS device is hibernating. Most of the data is read from the TLC/QLC area. A small amount of data may be read from the SLC cache because the data has not yet migrated to the TLC/QLC area when the data is read shortly after it is written.

Since most applications do not require or use high bandwidth when writing data, writing data from these applications to the SLC cache by using the TW technique may result in the SLC cache not having enough space to store data that requires high bandwidth writes, which may lead to performance degradation in high-bandwidth scenarios.

### SUMMARY

Some example embodiments may provide a data storage method and/or device so that at least one of the above problems in the related art is solved or improved upon.

According to some example embodiments, there is provided a data storage method including: determining, in response to receiving an Input/Output (IO) request, a data response level for the IO request; determining, according to the data response level, a storage area associated with storing data to be written corresponding to the IO request in a universal flash storage (UFS) device comprising a high speed buffer and a normal storage area, the high speed buffer comprising a first area, a second area, and a third area; and writing the data to be written into the determined storage area. The UFS device is configured to flush data stored in the first area into the normal storage area based on a first rule, flush data stored in the second area into the normal storage area based on a second rule, and block data stored in the third area into the normal storage area from being flushed. The data read and write speeds of the high speed buffer are greater than the respective read and write speeds of the normal storage area. The first area, the second area, and the third area and the normal storage area correspond to different data response levels, respectively.

Alternatively or additionally according to some example embodiments, there is provided a universal flash storage (UFS) data storage device including: a first determining unit configured to determine, in response to receiving an Input/Output (IO) request, a data response level associated with the IO request; a second determining unit configured to determine, based on the data response level, a storage area in the UFS device associated with storing data to be written corresponding to the IO request; and a writing unit configured to write the data to be written into the determined storage area. The UFS device includes a high speed buffer and a normal storage area. The high speed buffer includes a first area, a second area, and a third area. The UFS device is configured to flush data stored in the first area into the normal storage area based on a first rule, flush data stored in the second area into the normal storage area based on a second rule, and to block stored in the third area into the normal storage area from being flushed. The data read and write speeds of the high speed buffer are greater than the respective read and write speeds of the normal storage area, The first area, the second area, the third area, and the normal storage area correspond to different data response levels, respectively.

### BRIEF DESCRIPTION OF DRAWINGS

The above and other purposes and/or features of some example embodiments will become more apparent through the following descriptions made in conjunction with the figures schematically illustrating the embodiments, in which:

FIGS. 1A and 1B illustrate an example of data read and write speeds during operation of a particular game application and an example of data read and write speeds during operation of a particular shopping application;

FIG. 2 illustrates a schematic diagram of an example of reading and writing data based on TW technology;

FIG. 3 illustrates a diagram of an example of writing data based on TW technology in the related art;

FIG. 4 illustrates a schematic diagram of a data storage method according to some example embodiments;

FIG. 5 illustrates a flowchart of a data storage method according to some example embodiments;

FIG. 6 illustrates an overall architectural diagram of an example of data reading method according to some example embodiments;

FIG. 7 illustrates a schematic diagram of an example of a pinning stream manager;

FIG. 8 illustrates an example of a correspondence relationship between a type of process and an oom_adj score;

FIG. 9 illustrates an example flowchart of cleaning invalid data according to some example embodiments; and

FIG. 10 is a block diagram illustrating a structure of a data storage device according to some example embodiments.

### DETAILED DESCRIPTION

At least some aspects of the current disclosure may provide a data storage method that may utilize the SLC cache to improve data writing performance of the storage device.

Hereinafter, various example embodiments are described with reference to the accompanying drawings, in which like reference numerals are used to depict the same or similar elements, features, and structures. However, inventive concepts are not intended to be limited by the various example embodiments described herein to a specific embodiment and it is intended that inventive concepts covers all modifications, equivalents, and/or alternatives of example embodiments, provided they come within the scope of the appended claims and their equivalents. The terms and words used in the following description and claims are not limited to their dictionary meanings, but, are merely used to enable a clear and consistent understanding of inventive concepts. Accordingly, it should be apparent to those skilled in the art that the following description of various example embodiments of the present disclosure is provided for illustration purpose only and not for the purpose of limiting the present disclosure as defined by the appended claims and their equivalents.

It is to be understood that the singular forms include plural forms, unless the context clearly dictates otherwise. The terms “include,” “include,” and “have”, used herein, indicate disclosed functions, operations, or the existence of elements, but does not exclude other functions, operations, or elements.

For example, the expressions “A or B,” or “at least one of A and/or B” may indicate A and B, A, or B. For instance, the expression “A or B” or “at least one of A and/or B” may indicate (1) A, (2) B, or (3) both A and B.

In various example embodiments, it is intended that when a component (for example, a first component) is referred to as being “coupled” or “connected” with/to another component (for example, a second component), the component may be directly connected to the other component or may be connected through another component (for example, a third component). In contrast, when a component (for example, a first component) is referred to as being “directly coupled” or “directly connected” with/to another component (for example, a second component), another component (for example, a third component) does not exist between the component and the other component.

The expression “configured to”, used in describing various embodiments of the present disclosure, may be used interchangeably with expressions such as “suitable for,” “having the capacity to,” “designed to,” “adapted to,” “made to,” and “capable of”, for example, according to the situation. The term “configured to” may not necessarily indicate “specifically designed to” in terms of hardware. Instead, the expression “a device configured to” in some situations may indicate that the device and another device or part are “capable of.” For example, the expression “a processor configured to perform A, B, and C” may indicate a dedicated processor (for example, an embedded processor) for performing a corresponding operation or a general purpose processor (for example, a central processing unit (CPU) or an application processor (AP)) for performing corresponding operations by executing at least one software program stored in a memory device.

The terms used herein are to describe certain example embodiments, but are not intended to limit the scope of other embodiments. Unless otherwise indicated herein, all terms used herein, including technical or scientific terms, may have the same meanings that are generally understood by a person skilled in the art. In general, terms defined in a dictionary should be considered to have the same meanings as the contextual meanings in the related art, and, unless clearly defined herein, should not be understood differently or as having an excessively formal meaning. In any case, even terms defined are not intended to be interpreted as excluding other example embodiments.

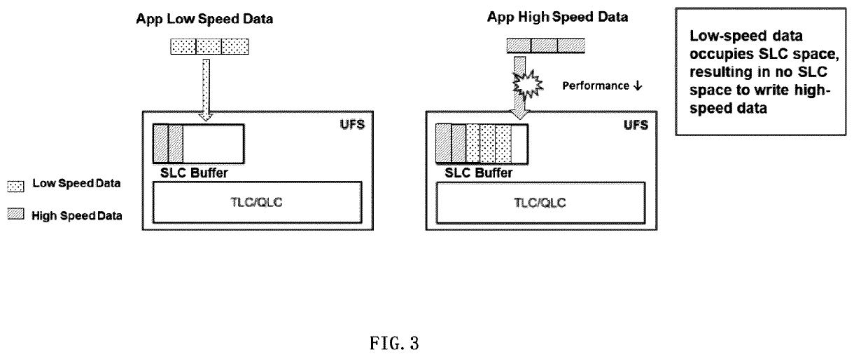

FIG. 3 illustrates a schematic diagram of an example of writing data based on TW technology in related art.

Referring to FIG. 3, after writing low-speed data of applications to the SLC cache, when high-speed data needs to be written, a degradation of data writing performance may occur, since the SLC cache does not have sufficient storage space to store the high-speed data.

The low-speed data may refer to data having a low read speed and/or write speed or data that is to be read and/or written with a low speed, while the high-speed data may refer to data having a high read and/or write speed or data that is to be read and/or written with a high speed.

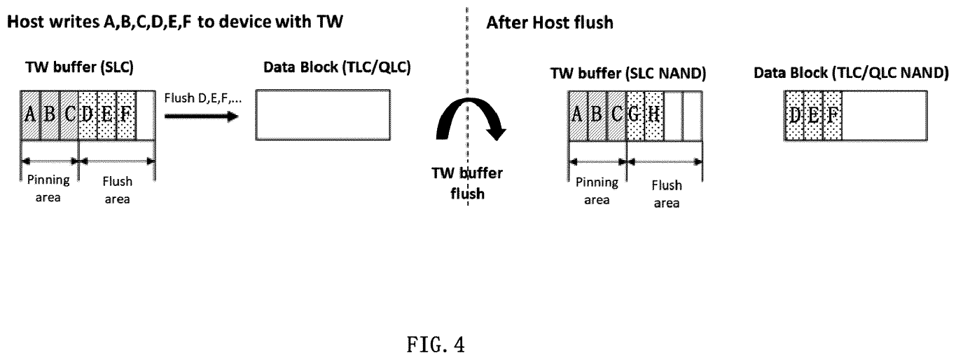

FIG. 4 illustrates a schematic diagram of a data storage method according to some example embodiments.

Referring to FIG. 4, the SLC buffer may be divided into a pinning area and a flushing area, and only data in the flushing area may be flushed into the TLC/QLC area when the UFS is in a hibernation state. This ensures or helps to ensure that data written to the pinning area can always or almost always be read with a high speed, and ensures or helps to ensure that the SLC buffer has sufficient storage space by flushing data in the flushing area into the TLC/QLC area.

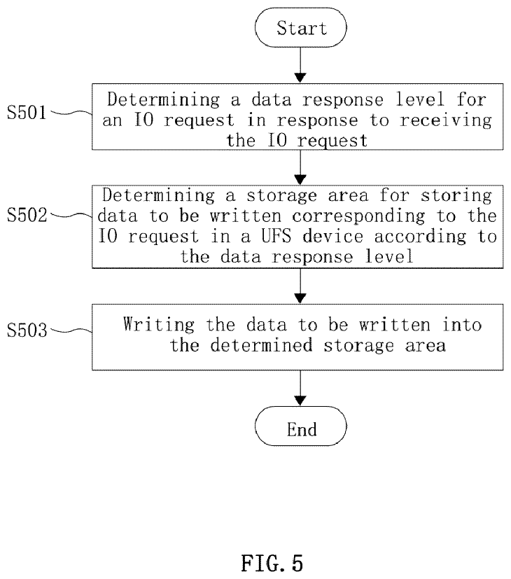

FIG. 5 illustrates a flowchart of a data storage method according to some example embodiments.

Referring to FIG. 5, at operation S501, a data response level for an IO request is determined in response to receiving the IO request.

As A high data response level indicates that the IO request requires a high data read and/or write speed. For example, a high data response level for a particular IO request indicates it requires quickly reading the data corresponding to the IO request and/or quickly writing the data corresponding to the IO request.

At operation S502, a storage area for storing data to be written corresponding to the IO request in the UFS device is determined based on the data response level. Different storage areas of the UFS device correspond to different data response levels, and such correspondence relationship may be determined in advance.

At operation S503, the data to be written is written into the determined storage area, wherein the UFS device includes a high speed buffer and a normal storage area. The high speed buffer includes a first area, a second area, and a third area. Data stored in the first area is flushed into the normal storage area based on a first rule such as a first preset rule, data stored in the second area is flushed into the normal storage area based on a second rule such as a second preset rule, and data stored in the third area is blocked, e.g., is not flushed or is inhibited from being transferred into the normal storage area. The data read and write speeds of the high speed buffer are greater than the read and write speeds of the normal storage area. The first area, the second area, and the third area and the normal storage area correspond to different data response levels, respectively.

As an example, the first rule may indicate that the data in the first area is flushed into the normal storage area when the UFS device enters a hibernation mode, and the second rule may indicate that the data in the first area is flushed into the normal storage area when the process changes from a foreground process to a background process.

Hereafter, the first area, the second area and the third area may be referred to as a Normal TW Area (NTA), a Temporary Pinning Area (TPA), and a Durable Pinning Area (DPA), respectively.

As an example, the normal storage area may be or may include a multi-layer cell flash memory area and the high speed buffer may be or may include an SLC flash memory area.

A SLC area, a SLC flash memory area, and a SLC buffer have the same meaning, and thus may be used interchangeably.

As an example, a normal storage area (or a multi-layer cell flash memory area) may be or may include a TLC/QLC area.

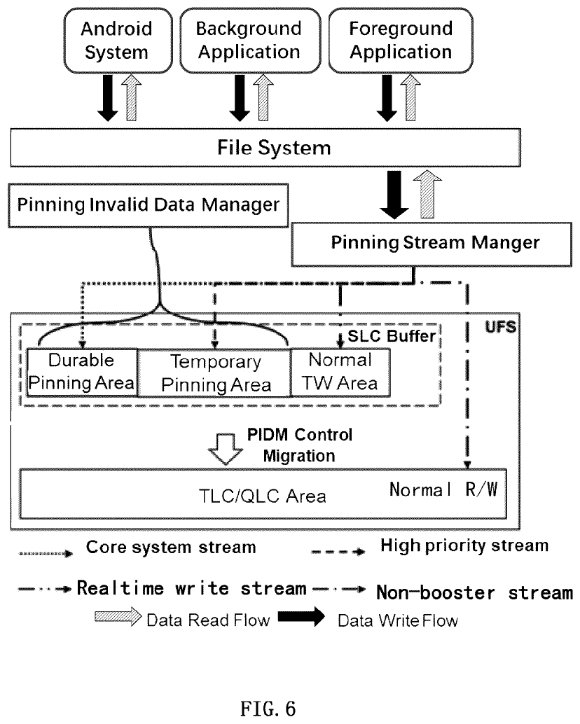

FIG. 6 illustrates an overall architectural diagram of an example of a data reading method according to some example embodiments.

Referring to FIG. 6, the storage area for storing the data to be written corresponding to the IO request in the UFS device may be determined by a pinning stream manager.

As an example, the pinning stream manager may determine a data response level for the IO request and may determine the storage area for storing the data to be written corresponding to the IO request in the UFS device based on the determined data response level.

Alternatively or additionally, the pinning stream manager may determine a data response level for the IO request based on information associated with the IO request.

Alternatively or additionally, the pinning stream manager may determine the data response level for the IO request based on a priority of the data to be written and/or a writing speed required for the data to be written.

Alternatively or additionally, the pinning stream manager may classify the data to be written into a core system stream, a high priority stream, a real time write stream, and a non-booster stream based on the priority of the data to be written and/or the write speed required for the data to be written or the data response level for the IO request. In some example embodiments, the core system stream permanently requires or uses a high read/write speed, the high priority stream temporally requires or uses a high read/write speed, the real time write stream only requires or uses a high write speed, and the non-booster stream requires or uses a normal write speed.

Alternatively or additionally, the core system stream, the high-priority stream, the real time write stream, and the non-booster stream may be written to the third area, the second area, the first area, and the normal storage area, respectively.

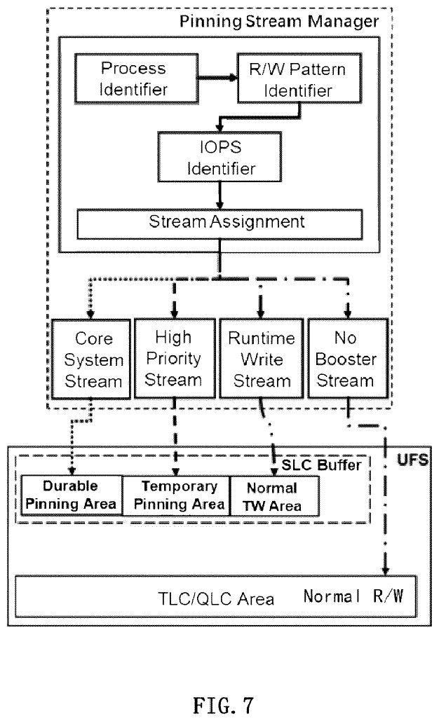

FIG. 7 illustrates a schematic diagram of an example of the pinning stream manager.

Referring to FIG. 7, the pinning stream manager may include a process identifier, a read/write (R/W) pattern identifier, an Input/Output Operations Per Second (IOPS) identifier, and a stream allocator.

The pinning stream manager may include other modules and modules included in the pinning stream manager may be divided and/or combined.

As an example, operation S501 may include determining the data response level based on at least one of a type of a process corresponding to the IO request, a type of the IO request, and IO Operations Per Second (IOPS) of the process. The type of process indicates one of a foreground process, a background process, and a core process, and the type of the IO request is indicative of one of a read operation request, a write operation request, and a read & write operation request.

Alternatively or additionally, operation S501 may include: determining the data response level as a first level when a first condition is satisfied, wherein the first condition indicates that the process is the foreground process and the IO request is a write operation request; determining the data response level as a second level when a second condition is satisfied, wherein the second condition indicates that the process is the foreground process, the IO request is a read & write operation request and a ratio of the IOPS of the process to a maximum IOPS of the normal storage area is greater than a first threshold value; determining the data response level as a third level when a third condition is satisfied, wherein the third condition indicates that the process is the core process and the ratio of the IOPS of the process to the maximum IOPS of the normal storage area is greater than the first threshold value; and determining the data response level as a zero-th level when the first condition, the second condition and the third condition are not satisfied, wherein the normal storage area, the first area, the second area, and the third area correspond to the zero-th level, the first level, the second level, and the third level, respectively.

Alternatively or additionally, a process identifier may be utilized to identify the type of process corresponding to the IO request and label the data to be written. For example, when it is determined that the process is a system process or a core process, the data to be written may be labeled as being corresponding to the core process.

Alternatively or additionally, the type of the process may be determined based on an Out of Memory Adjustment (oom_adj) score for the process.

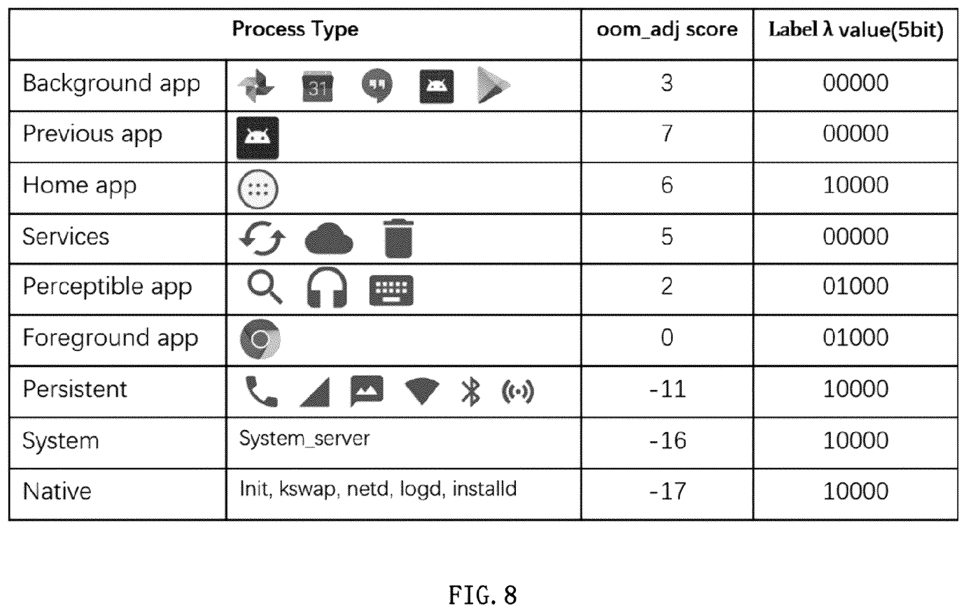

FIG. 8 illustrates an example of correspondence relationship between the type of process and the oom_adj score.

Referring to FIG. 8, the process type label Labelλ of the core process or home apps is labelled as 10000, the Labelλ of the foreground process is labelled as 01000, and the Labelλ of the background process is labeled as 00000.

As an example, the type of read/write operation corresponding to the IO request may be determined by an R/W pattern identifier.

As an example, the type label Labelμ of the write operation may be represented as 00100, the Labelμ of the read operation may be represented as 00010, and the Labelμ of the write & read operation may be represented as 00110.

As an example, the IOPS identifier may be used to determine whether the data to be written corresponds to a high IPOS or a low IOPS.

As an example, a maximum IOPS of the normal storage area of the UFS device, which may be denoted as υ_{low}, and an IOPS of the process corresponding to the IO request, which may be denoted as υ_{ρ}, may be measured, and it may be determined that the data to be written corresponds to a high IOPS when υ_{ρ}≥0.8*υ_{low}; it may be determined that the data to be written corresponds to a low IOPS when υ_{ρ}<0.8*υ_{low}; and the high IOPS may be denoted as 00001 and the low IOPS may be denoted as 00000.

As an example, the sum label Labelsum of the data to be written may be calculated according to the following equation:

$${Label}_{sum} = {Label}_{λ} ∨ {Label}_{μ} ∨ {Label}_{ρ} .$$

As an example, the value f(D_{w}) of the data weight D_{w} may be calculated based on the following equation:

$$f ( {D}_{w} ) = \{ \begin{matrix}0 , & {Label}_{sum} ∧ 11000 = 0 \\ 1 , & ( {Label}_{sum} ∧ 01000 ) \neq 0 ∧ ( {Label}_{sum} ∧ 00010 ) = 0 \\ 2 , & \begin{matrix}( {Label}_{sum} ∧ 01000 ) \neq 0 ∧ ( {Label}_{sum} ∧ 00010 ) \neq \\ 0 ∧ ( {Label}_{sum} ∧ 00001 ) \neq 0\end{matrix} \\ 3 , & ( {Label}_{sum} ∧ 10000 ) \neq 0 ∧ ( {Label}_{sum} ∧ 00001 ) \neq 0\end{matrix}$$

The f(D_{w}) of D_{w} corresponding to other cases not shown in the above equation may be 0, that is, the f(D_{w}) of D_{w} for cases other than those corresponding to values 1, 2, and 3 is 0.

As an example, the data may be streamed in accordance with Table 1 below.

TABLE 1

| | Data | | |
|---|---|---|---|
| Data | response | | |
| weight | level | stream | Data storage location |
| 0 | Low | Non-booster stream | Normal storage area |
| 1 | Middle | Realtime write stream | Normal TW area |
| 2 | High | High priority stream | Temporary pinning area |
| 3 | Urgency | Core system stream | Durable pinning area |

The above describes specific implementations for determining a storage location for data to be written based on the type of process corresponding to the IO request, the type of the IO request, and the IOPS of the process, the foregoing implementations are only examples and do not limit example embodiments.

As an example, the storage location for the data to be written may be determined based only on the type of the process. For example, the data corresponding to the core process is written into the durable pinning area, data corresponding to the foreground process is written into the temporary pinning area, and data corresponding to the background process is written into the normal TW area and/or the normal storage area.

Alternatively or additionally, the storage location corresponding to the data to be written may be determined based only on the IOPS of the process. For example, the data to be written corresponding to the process with a ratio of υ_{ρ} to υ_{low} being greater than a first threshold such as a first predetermined threshold may be stored to the durable pinning area, the data to be written corresponding to the process with the ratio of υ_{ρ} to υ_{low} being not greater than the first threshold value and being greater than a second threshold such as a second predetermined threshold may be stored to the temporary pinning area, the data to be written corresponding to the process with the ratio of υ_{ρ} to υ_{low} not being greater than the second threshold and being greater than a third threshold such as a third predetermined threshold is stored into the normal TW area, and the data to be written corresponding to the process with the ratio of υ_{ρ} to υ_{low} not being greater than the third threshold is stored into the normal storage area.

The data storage areas in the DPA and the TPA may have a lot of invalid data as the data is written, and thus the invalid data needs to be cleaned.

As an example, the method shown in FIG. 5 may further include: determining whether remaining available storage space in the second area and/or the third area is less than a second threshold value; determining whether a ratio of invalid data in the third area to data stored in the third data is greater than a third threshold value when the remaining available storage space is less than the second threshold value; allocating another area in the high speed buffer as a new third area based on the result of determining of whether the ratio of the invalid data in the third area to the data stored in the third area is greater than the third threshold; migrating (e.g., copying and deleting) valid data in the third area to the other area; deleting the data in the third area; and migrating at least portion of data with a high read frequency in the normal storage area to the other area.

Alternatively or additionally, the allocating of another area includes: allocating the other area having a storage capacity that is the same as the storage capacity of the third area in the cache region as the new third area, when the ratio of the invalid data in the third area to the data stored in the first area is greater than the third threshold value; and/or, allocating the other area having a storage capacity that is greater than the storage capacity of the third area in the cache region as the new third area, when the ratio of the invalid data in the third area to the data stored in the first area is not greater than the third threshold value.

Alternatively or additionally, the method shown in FIG. 5 may further include: migrating data in the second area to the normal storage area and delete the data in the second area when the remaining available storage space in the second area and/or the third area is less than the second threshold value; and/or, determining whether a ratio of the invalid data in the second area to the data stored in the second area is greater than a fourth threshold value, and expanding storage capacity of the second area when the ratio of the invalid data in the second area to the data stored in the second area is not greater than the fourth threshold value.

As an example, the invalid data may be cleaned, for example by using a Pinning Invalid Data Manager (PIDM) module.

As an example, the PIDM module may include one or more of a space monitor, an invalid data monitor, a space size manager, a pining garbage collection controller, and a migration controller.

The PIDM module may also include other modules, any of the modules included therein may be divided, and at least two of the modules included therein may be combined.

Alternatively or additionally, the space monitor may monitor states of remaining space of the DPA, TPA, and/or NTA.

Alternatively or additionally, the invalid data monitor may monitor a ratio of invalid data in the DPA and/or TPA to data stored in the DPA and/or TPA.

Alternatively or additionally, when the space monitor monitors that the remaining available storage space in the DPA and/or the TPA is less than a threshold such as a preset threshold, the invalid data monitor may monitor or calculate a ratio of invalid data in the DPA and/or the TPA to data stored in the DPA and/or the TPA.

Alternatively or additionally, when a ratio of the invalid data in the DPA to the data stored in the DPA is greater than the threshold, the space size manager may allocate another area in the SLC buffer as a new DPA, wherein storage capacity of the new DPA is the same as storage capacity of original DPA; when the ratio of the invalid data in the DPA to the data stored in the DPA is not greater than the threshold, the space size manager may allocate another area having storage capacity greater than the storage capacity of the original DPA in the SLC buffer as the new DPA.

Alternatively or additionally, after operations of the space size manager are completed, the pinning garbage collection controller may migrate valid data in the original DPA to the new DPA and release the original DPA.

Furthermore, after the valid data in the original DPA is migrated to the new DPA, a portion of data with a high read frequency in the normal storage area may be migrated to the remaining storage space in the new DPA.

Alternatively or additionally, when it is determined that the remaining storage capacity of the DPA and/or the TPA is less than a threshold value, the migration controller may migrate the data in the TPA into the normal storage area.

Alternatively or additionally, the TPA may also be enlarged (e.g., the storage capacity of the enlarged TPA is increased by 20%) when the ratio of invalid data in the TPA to the data stored in the TPA is less than a threshold.

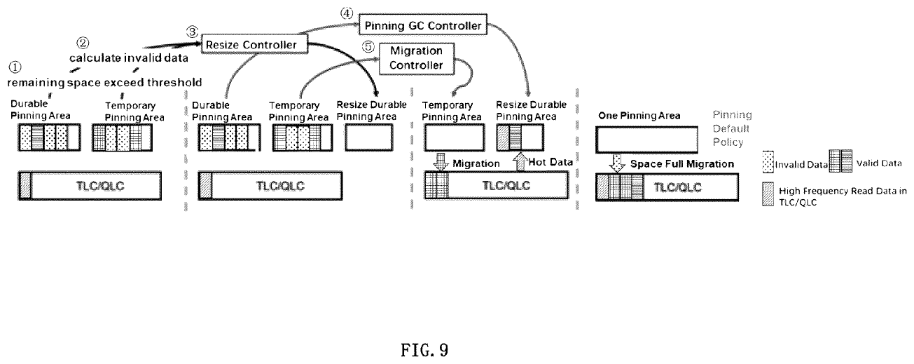

FIG. 9 illustrates an example flowchart of an example cleaning invalid data according to some example embodiments.

Referring to FIG. 9, at operation \textcircled{1}, it may be determined whether remaining storage space of the DPA and/or the TPA is less than a threshold value.

At operation \textcircled{2}, when the remaining storage space of the DPA and/or the TPA is less than the threshold, a ratio of invalid data in the DPA and/or TPA to all data stored in the DPA and/or TPA is calculated.

At operation \textcircled{3}, the size of the DPA and/or the TPA is adjusted according to the ratio calculated at operation \textcircled{2}. As described above, when the ratio of the invalid data in the DPA is greater than the threshold value, another high speed buffer of which storage space size is the same as that of the original DPA is allocated as the new DPA, otherwise another high speed buffer with a greater storage space is allocated as the new DPA. At operation \textcircled{4}, the valid data in the original DPA is migrated to the new DPA and the original DPA is released. In addition, at least part of data with a high access frequency in the TLC/QLC is migrated to the new DPA.

At operation \textcircled{5}, valid data in the TPA is migrated to the TLC/QLC. Furthermore, although not shown in FIG. 9, if the ratio of invalid data in the TPA to data stored in the TPA is less than a threshold value, the TPA may be expanded when the valid data in the TPA are migrated into the TLC/QLC.

Compared to the method in the related art of cleaning invalid data by migrating all valid data in the pinning area into the TLC/QLC, the method according to some example embodiments may help to ensure that a portion of data (e.g., the data in the TPA region) with a high access frequency is always stored or is more likely to be stored in a high speed buffer so that the portion of the data may be accessed quickly.

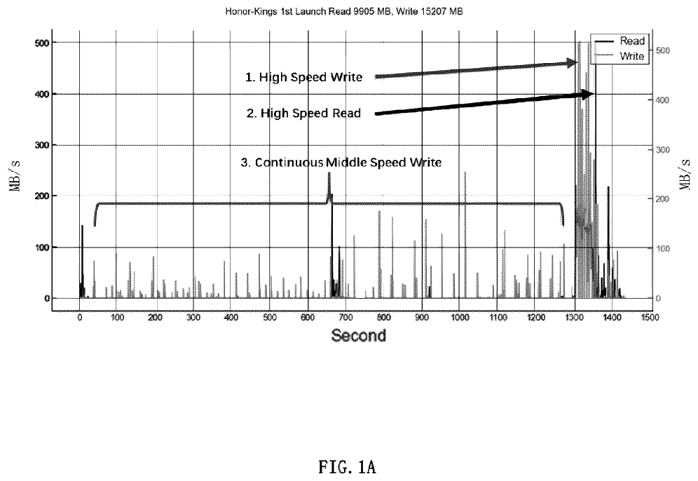

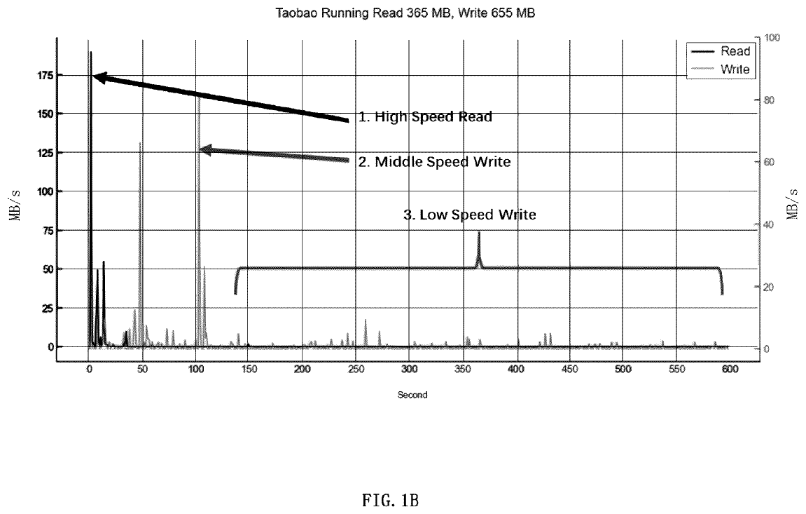

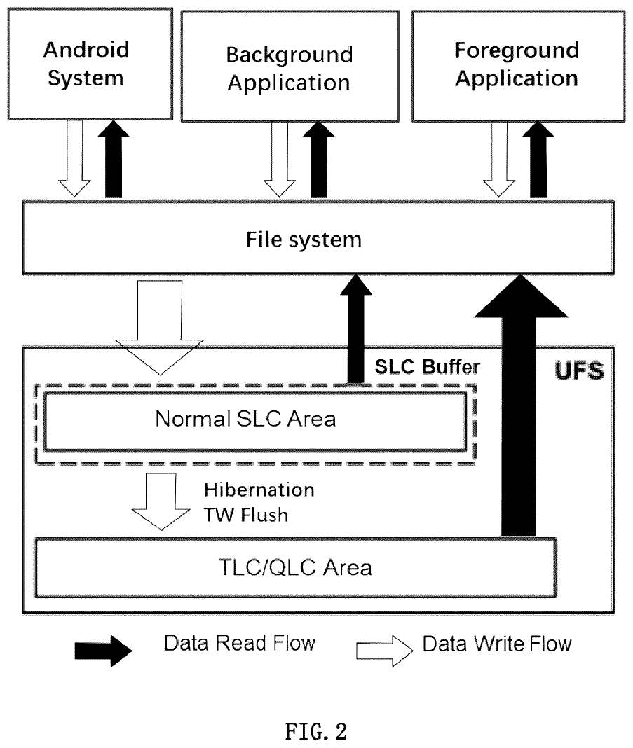

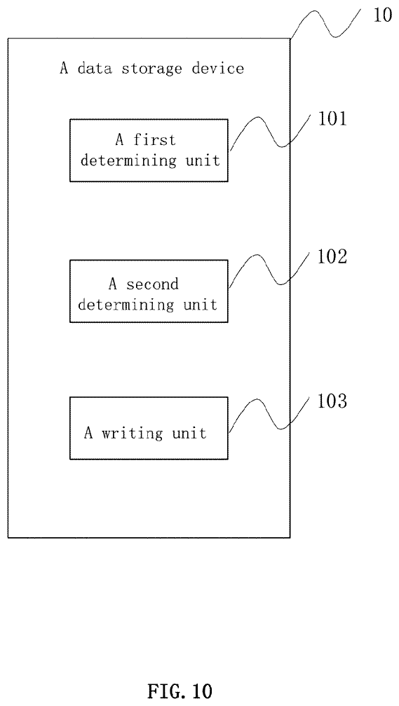

The data storage method according to some example embodiments is described above with reference to FIGS. 1 to 9, and the data storage device according to some example embodiments is described below with reference to FIG. 10.

Referring to FIG. 10, the data storage device 10 may include a first determining unit 101, a second determining unit 102, and a writing unit 103. The data storage device 10 may additionally include other components, and at least one of the components included in the data storage device 10 may be combined or divided.

As an example, the first determination unit 101 may be configured to determine, in response to receiving an Input/Output (IO) request, a data response level for the IO request.

Alternatively or additionally, the second determination unit 102 may be configured to determine, based on the data response level, a storage area in the UFS device for storing data to be written corresponding to the IO request.

Alternatively or additionally, the writing unit 103 may be configured to write the data to be written into the determined storage area, wherein the UFS device includes a high speed buffer and a normal storage area, wherein the high speed buffer includes a first area, a second area, and a third area, wherein data stored in the first area is flushed into the normal storage area based on a first preset rule, data stored in the second area is flushed into the normal storage area based on a second preset rule, data stored in the third area is blocked, e.g., is not flushed or is inhibited from being transferred into the normal storage area, wherein the data read and write speeds of the high speed buffer are greater than the read and write speeds of the normal storage area, wherein the first area, the second area, and the third area and the normal storage area correspond to different data response levels, respectively.

Alternatively or additionally, the first determining unit 101 may be configured to determine the data response level based on at least one of a type of a process corresponding to the IO request, a type of the IO request, and IO Operations Per Second (IOPS) of the process, wherein the type of process is indicative of one of a foreground process, a background process, and a core process, and the type of the IO request is indicative of one of a read operation request, a write operation request, and a read & write operation request.

Alternatively or additionally, the first determining unit 101 may be configured to: determine the data response level as a first level when a first condition is satisfied, wherein the first condition indicates that the process is the foreground process and the IO request is a write operation request; determine the data response level as a second level when a second condition is satisfied, wherein the second condition indicates that the process is the foreground process, the IO request is a read & write operation request and a ratio of the IOPS of the process to a maximum IOPS of the normal storage area is greater than a first threshold value; determine the data response level as a third level when a third condition is satisfied, wherein the third condition indicates that the process is the core process and the ratio of the IOPS of the process to the maximum IOPS of the normal storage area is greater than the first threshold value; and determine the data response level as a zero-th level when the first condition, the second condition and the third condition are not satisfied, wherein the normal storage area, the first area, the second area, and the third area correspond to the zero-th level, the first level, the second level, and the third level, respectively.

Alternatively or additionally, the first rule may indicate that the data in the first area is flushed into the normal storage area when the UFS device enters a hibernation mode, and the second rule may indicate that the data in the first area is flushed into the normal storage area when the process changes from the foreground process to the background process.

As an example, the data storage device 10 may further include a first invalid data managing unit configured to: determine whether remaining available storage space in the second area and/or the third area is less than a second threshold value; determine whether a ratio of invalid data in the third area to data stored in the third data is greater than a third threshold value when the remaining available storage space is less than the second threshold value; allocate another area in the high speed buffer as a new third area based on the result of determining of whether the ratio of the invalid data in the third area to the data stored in the third area is greater than the third threshold; migrate valid data in the third area to the other area; delete the data in the third area; and migrate at least portion of data with a high read frequency in the normal storage area to the other area.

Alternatively or additionally, the first invalid data management unit may be configured to: allocate the other area having a storage capacity that is the same as the storage capacity of the third area in the cache region as the new third area, when the ratio of the invalid data in the third area to the data stored in the first area is greater than the third threshold value; and/or, allocate the other area having a storage capacity that is greater than the storage capacity of the third area in the cache region as the new third area, when the ratio of the invalid data in the third area to the data stored in the first area is not greater than the third threshold value.

Alternatively or additionally, the data storage device 10 may further include a second invalid data managing unit configured to: migrate data in the second area to the normal storage area and delete the data in the second area when the remaining available storage space in the second area and/or the third area is less than the second threshold value; and/or, determine whether a ratio of the invalid data in the second area to the data stored in the second area is greater than a fourth threshold value, and expanding storage capacity of the second area when the ratio of the invalid data in the second area to the data stored in the second area is not greater than the fourth threshold value.

Alternatively or additionally, the high speed buffer is a single-level cell flash memory and the normal storage area is a multi-level cell flash memory.

According to some example embodiments, there is provided a computer readable storage medium storing a computer program that when executed by a processor causes the processor to implement the data storage method as described herein. Examples of computer-readable storage media here include one or more of: read only memory (ROM), random access programmable read only memory (PROM), electrically erasable programmable read only memory (EEPROM), random access memory (RAM), dynamic random access memory (DRAM), static random access memory (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blu-ray or optical disc storage, hard disk drive (HDD), solid state Hard disk (SSD), card storage (such as one or more of multimedia card, secure digital (SD) card or extreme digital (XD) card), magnetic tape, floppy disk, magneto-optical data storage device, optical data storage device, hard disk, solid state disk and any other devices configured to store computer programs and any associated data, data files, and data structures in a non-transitory manner, and provide the computer programs and any associated data, data files, and data structures to the processor or the computer, so that the processor or the computer can execute the computer program. The computer program in the above-mentioned computer-readable storage medium may run in an environment deployed in computing equipment such as a client, a host, an agent device, a server, etc. In addition, in one example, the computer program and any associated data, data files and data structures are distributed on networked computer systems, so that computer programs and any associated data, data files, and data structures are stored, accessed, and executed in a distributed manner through one or more processors or computers.

Referring to FIG. 10, any or all of the elements listed in FIG. 10 may communicate with any or all of the other elements listed in FIG. 10, to transmit and/or information, in a one-way, two-way, or multiway (e.g., broadcast) manner, over a bus such as a wired and/or a wireless bus. The information may be or may include data and/or instructions, and may be in an analog and/or digital format; example embodiments are not limited thereto.

According to some example embodiments, there may be provided a computer program product, wherein instructions in the computer program product may be executed by a processor of a computer device to implement the data storage method described herein.

Any of the elements and/or functional blocks disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc. The processing circuitry may include electrical components such as logic gates including at least one of AND gates, OR gates, NAND gates, NOT gates, etc.

Those of ordinary skill in the art will easily think of other embodiments of the present disclosure after considering the specification and practicing the disclosure disclosed herein. The present disclosure is intended to cover any variations, uses, or adaptive changes of the present disclosure. These variations, uses, or adaptive changes follow the general principles of the present disclosure and include common knowledge or conventional technical means in the technical field that are not disclosed in the present disclosure. The specification and the embodiments are to be regarded as examples only, and the actual scope and spirit of inventive concepts are pointed out by the following claims. Additionally, example embodiments are not necessarily mutually exclusive with one another. For example, some example embodiments may include one or more features described with reference to one or more figures, and may also include one or more other features described with reference to one or more other figures.

What is claimed is:

1. A data storage method, comprising:
determining, in response to receiving an Input/Output (IO) request, a data response level associated with the IO request;
determining, according to the data response level, a storage area associated with storing data to be written corresponding to the IO request in a universal flash storage (UFS) device comprising a high speed buffer and a normal storage area, the high speed buffer comprising a first area, a second area, and a third area; and
writing the data to be written into the determined storage area,
wherein the UFS device is configured to flush data stored in the first area into the normal storage area based on a first rule, flush data stored in the second area into the normal storage area based on a second rule, and block data stored in the third area from being flushed into the normal storage area,
wherein read and write speeds of the high speed buffer are greater than respective read and write speeds of the normal storage area, and
wherein the first area, the second area, the third area, and the normal storage area correspond to different data response levels, respectively.

2. The method of claim 1, wherein the determining of the data response level comprises:
determining the data response level based on at least one of a type of a process corresponding to the IO request, a type of the IO request, and IO Operations Per Second (IOPS) of the process, wherein
the type of process indicates one of a foreground process, a background process, and a core process, and
the type of the IO request indicates one of a read operation request, a write operation request, and a read & write operation request.

3. The method of claim 2, wherein the determining of the data response level comprises:
determining the data response level as a first level in response to a first condition being satisfied, wherein the first condition indicates that the process is the foreground process and the IO request corresponds to a write operation request;
determining the data response level as a second level in response to a second condition being satisfied, wherein the second condition indicates that the process is the foreground process, the IO request corresponds to a read & write operation request and a value based on a ratio of the IOPS of the process to a maximum IOPS of the normal storage area is greater than a first threshold value;
determining the data response level as a third level in response to a third condition being satisfied, wherein the third condition indicates that the process is a core process and the value based on the ratio of the IOPS of the process to the maximum IOPS of the normal storage area is greater than the first threshold value; and
determining the data response level as a zero-th level in response to the first condition, the second condition and the third condition not being satisfied,
wherein the normal storage area, the first area, the second area, and the third area correspond to the zero-th level, the first level, the second level, and the third level, respectively.

4. The method of claim 3, wherein the first rule indicates that the UFS device is to flush data in the first area into the normal storage area in response to the UFS device entering a hibernation mode, and
the second rule indicates that the UFS device is to flush data in the first area into the normal storage area in response to the process changing from the foreground process to the background process.

5. The method of claim 1, further comprising:
determining whether remaining available storage space in the second area or remaining available storage space in the third area is less than a second threshold value;
determining whether a ratio of invalid data in the third area to data stored in the third data is greater than a third threshold value in response to the remaining available storage space being less than the second threshold value;
allocating another area in the high speed buffer as a new third area based on a result of determining of whether the ratio of the invalid data in the third area to the data stored in the third area is greater than the third threshold;
copying valid data in the third area to the other area;
deleting the data in the third area; and
copying at least portion of data with a high read frequency in the normal storage area to the other area.

6. The method of claim 5, wherein the allocating of another area comprises:
allocating the other area having a storage capacity the same as storage capacity of the third area in a cache region as the new third area, in response to the ratio of the invalid data in the third area to the data stored in the first area being greater than the third threshold value; and
allocating the other area having a storage capacity greater than the storage capacity of the third area in the cache region as the new third area, in response to the ratio of the invalid data in the third area to the data stored in the first area equal to or less than the third threshold value.

7. The method of claim 5, further comprising:
copying data in the second area to the normal storage area and deleting the data in the second area in response to the remaining available storage space in the second area or the third area being less than the second threshold value; and
determining whether a ratio of the invalid data in the second area to the data stored in the second area is greater than a fourth threshold value, and expanding storage capacity of the second area in response to the ratio of the invalid data in the second area to the data stored in the second area being equal to or less than the fourth threshold value.

8. The method of claim 1, wherein the high speed buffer includes a single-level cell flash memory and the normal storage area includes a multi-level cell flash memory.

9. A universal flash storage (UFS) data storage device, comprising:
a first determining unit configured to determine, in response to receiving an Input/Output (IO) request, a data response level associated with the IO request;
a second determining unit configured to determine, based on the data response level, a storage area in the UFS device associated with storing data to be written corresponding to the IO request;
a writing unit configured to write the data to be written into the determined storage area,
a high speed buffer; and
a normal storage area, wherein
the high speed buffer comprises a first area, a second area, and a third area,
the UFS device is configured to flush data stored in the first area into the normal storage area based on a first rule, to flush data stored in the second area into the normal storage area based on a second rule, and to block data stored in the third area into the normal storage area from being flushed,
the read and write speeds of the high speed buffer are greater than the respective read and write speeds of the normal storage area, and
the first area, the second area, the third area, and the normal storage area correspond to different data response levels, respectively.

10. The data storage device of claim 9, wherein the first determining unit is configured to determine the data response level based on at least one of a type of a process corresponding to the IO request, a type of the IO request, and IO Operations Per Second (IOPS) of the process, wherein
the type of process indicates one of a foreground process, a background process, and a core process, and
the type of the IO request indicates one of a read operation request, a write operation request, and a read & write operation request.

11. The data storage device of claim 10, wherein the first determining unit is configured to:
determine the data response level as a first level in response to a first condition being satisfied, wherein the first condition indicates that the process is the foreground process and the IO request corresponds to a write operation request;
determine the data response level as a second level in response to a second condition being satisfied, wherein the second condition indicates that the process is the foreground process, the IO request corresponds to a read & write operation request and a value based on a ratio of the IOPS of the process to a maximum IOPS of the normal storage area being greater than a first threshold value;
determine the data response level as a third level in response to a third condition being satisfied, wherein the third condition indicates that the process is a core process and the value based on the ratio of the IOPS of the process to the maximum IOPS of the normal storage area is greater than the first threshold value; and
determine the data response level as a zero-th level in response to the first condition, the second condition, and the third condition not being satisfied,
wherein the normal storage area, the first area, the second area, and the third area correspond to the zero-th level, the first level, the second level, and the third level, respectively.

12. The data storage device of claim 11, wherein the first rule indicates that the UFS is to flush data in the first area into the normal storage area in response to the UFS device entering a hibernation mode, and the second rule indicates that the data in the first area is flushed into the normal storage area in response to the process changes from the foreground process to the background process.

13. The data storage device of claim 9, further comprising:
a first invalid data managing unit configured to:
determine whether remaining available storage space in the second area and/or the third area is less than a second threshold value;
determine whether a ratio of invalid data in the third area to data stored in the third data is greater than a third threshold value in response to the remaining available storage space being less than the second threshold value;
allocate another area in the high speed buffer as a new third area based on a result of determining of whether the ratio of the invalid data in the third area to the data stored in the third area is greater than the third threshold;
copy valid data in the third area to the other area;
delete the data in the third area; and
copy at least portion of data with a high read frequency in the normal storage area to the other area.

14. The data storage device of claim 13, the first invalid data managing unit is configured to:
allocate the other area having a storage capacity that is the same as the storage capacity of the third area in a cache region as the new third area, in response to the ratio of the invalid data in the third area to the data stored in the first area being greater than the third threshold value;
and, allocate the other area having a storage capacity that is greater than the storage capacity of the third area in the cache region as the new third area, in response to the ratio of the invalid data in the third area to the data stored in the first area being equal to or less than the third threshold value.

15. The data storage device of claim 13, further comprising:
a second invalid data managing unit configured to:
copy data in the second area to the normal storage area and delete the data in the second area in response to the remaining available storage space in the second area or the third area being less than the second threshold value;
and, determine whether a ratio of the invalid data in the second area to the data stored in the second area is greater than a fourth threshold value, and expanding storage capacity of the second area in response to the ratio of the invalid data in the second area to the data stored in the second area being less than or equal to the fourth threshold value.

16. The data storage device of claim 9, wherein the high speed buffer includes a single-level cell flash memory and the normal storage area includes a multi-level cell flash memory.

17. A computer readable storage medium storing a computer program that when executed by a processor causes the processor to:
determining, in response to receiving an Input/Output (IO) request, a data response level associated with the IO request;
determining, according to the data response level, a storage area associated with storing data to be written corresponding to the IO request in a universal flash storage (UFS) device; and
writing the data to be written into the determined storage area, wherein
the UFS device comprises a high speed buffer and a normal storage area, the high speed buffer comprising a first area, a second area, and a third area,
the UFS device is configured to flush data stored in the first area into the normal storage area based on a first rule,
the UFS device is configured to flush data stored in the second area into the normal storage area based on a second rule,
the UFS device is configured to not flush data stored in the third area into the normal storage area,
read and write speeds of the high speed buffer are greater than respective read and write speeds of the normal storage area, and
the first area, the second area, the third area, and the normal storage area correspond to different data response levels, respectively.

18. The computer readable storage medium of claim 17, wherein the determining of the data response level comprises:
determining the data response level based on at least one of a type of a process corresponding to the IO request, a type of the IO request, and IO Operations Per Second (IOPS) of the process, wherein
the type of process indicates one of a foreground process, a background process, and a core process, and
the type of the IO request indicates one of a read operation request, a write operation request, and a read & write operation request.

19. The computer readable storage medium of claim 18, wherein the determining of the data response level comprises:
determining the data response level as a first level in response to a first condition being satisfied, wherein the first condition indicates that the process is the foreground process and the IO request corresponds to a write operation request;
determining the data response level as a second level in response to a second condition being satisfied, wherein the second condition indicates that the process is the foreground process, the IO request corresponds to a read & write operation request and a value based on a ratio of the IOPS of the process to a maximum IOPS of the normal storage area is greater than a first threshold value;
determining the data response level as a third level in response to a third condition being satisfied, wherein the third condition indicates that the process is a core process and the value based on the ratio of the IOPS of the process to the maximum IOPS of the normal storage area is greater than the first threshold value; and
determining the data response level as a zero-th level in response to the first condition, the second condition and the third condition not being satisfied,
wherein the normal storage area, the first area, the second area, and the third area correspond to the zero-th level, the first level, the second level, and the third level, respectively.

20. The computer readable storage medium of claim 19, wherein the first rule indicates that the UFS device is to flush data in the first area into the normal storage area in response to the UFS device entering a hibernation mode, and
the second rule indicates that the UFS device is to flush data in the first area into the normal storage area in response to the process changing from the foreground process to the background process.
